(19) United States
(12) Patent Application Publication
(10) Pub. No.: US 2012/0043893 A1
(43) Pub. Date: Feb. 23, 2012

(54) Dimmable LED Power Supply

(75) Inventors: Laurence P. Sadwick, Salt Lake City, UT (US); William B. Sackett, Sandy, UT (US)

(73) Assignee: InnoSys, Inc.

(21) Appl. No.: 13/170,111

(22) Filed: Jun. 27, 2011

Related U.S. Application Data
(60) Provisional application No. 61/359,305, filed on Jun. 28, 2010.

(51) Int. Cl. H05B 37/02

(52) U.S. Cl. 315/127; 315/224

(57) ABSTRACT

Various apparatuses, methods and systems for dimmably supplying power are disclosed herein. In some embodiments, an apparatus includes an input power terminal, a switch connected to the input power terminal, an inductor connected in series with the switch, a load terminal connected in series with the switch and with the inductor, and a variable pulse generator operable to control the switch to regulate a current to the load terminal based at least in part on a feedback signal from a node in series with the load terminal and at least in part on a voltage reference signal.

### BACKGROUND

Electricity is generated and distributed in alternating current (AC) form, wherein the voltage varies sinusoidally between a positive and a negative value. However, many electrical devices require a direct current (DC) supply of electricity having a constant voltage level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation. Electrical current flows through an individual LED easily in only one direction, and if a negative voltage which exceeds the reverse breakdown voltage of the LED is applied, the LED can be damaged or destroyed. Furthermore, the standard, nominal residential voltage level is typically something like 120 V or 240 V, both of which are higher than may be desired for a high efficiency LED light. Some conversion of the available power may therefore be necessary or highly desired with loads such as an LED light.

In one type of commonly used power supply for loads such as an LED, an incoming AC voltage is connected to the load only during certain portions of the sinusoidal waveform. For example, a fraction of each half cycle of the waveform may be used by connecting the incoming AC voltage to the load each time the incoming voltage rises to a predetermined level or reaches a predetermined phase and by disconnecting the incoming AC voltage from the load each time the incoming voltage again falls to zero. In this manner, a positive but reduced voltage may be provided to the load. This type of conversion scheme is often controlled so that a constant current is provided to the load even if the incoming AC voltage varies. However, if this type of power supply with current control is used in an LED light fixture or lamp, a conventional dimmer is often ineffective. For many LED power supplies, the power supply will attempt to maintain the constant current through the LED despite a drop in the incoming voltage by, for example, increasing the on-time during each cycle of the incoming AC wave.

### SUMMARY

The present invention provides a dimmable power supply for a variety of loads, including low-wattage light sources that do not present a purely resistive load or that present too high of a resistive load, such as LEDs. The dimmable power supply may be dimmed using existing dimmer circuits and devices. Existing dimmers include technologies such as a silicon controlled resistor (SCR), a TRIAC, and related types of devices which have difficulties in dimming low-wattage light sources, especially ones that do not present a purely resistive load, because these light sources do not present the minimum load required for an SCR or TRIAC to function properly.

This summary provides only a general outline of some particular embodiments and should not be viewed as limiting in any way or form. Many other objects, features, advantages and other embodiments will become more fully apparent from the following detailed description, the appended claims and the accompanying drawings.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts an example embodiment of a dimmable LED power supply.

FIG. 2 depicts an example embodiment of a dimmable LED power supply with input current sensing.

FIG. 3 depicts an example embodiment of a dimmable LED power supply with feedback components independent from the variable pulse generator.

FIG. 4 depicts a dimmable LED power supply with example time constants that may be selectively or inclusively included in various embodiments.

FIG. 5 depicts an example embodiment of a dimmable LED power supply with multiple current sense resistors used to monitor and control the LED and also the AC (or DC) input current.

FIGS. 6-8 depict various example embodiments in which many of the functions have been combined into one integrated circuit.

FIG. 9 depicts an example embodiment of a dimmable LED power supply with another current sense resistor placement which may be used in certain applications.

FIG. 10 depicts an example embodiment having a bandgap voltage reference.

### DESCRIPTION

The drawings and description, in general, disclose various embodiments of a dimmable LED power supply. The power supply may be used, for example, with a dimmer containing a TRIAC, but is not limited to this use. The system may also be used to improve performance of a dimmer containing a silicon-controlled rectifier (SCR) or any other type of forward or reverse dimmer that uses, for example but not limited to, one or more triacs, transistors, SCRs, thyristors, etc. The system is also operational when no dimmer is used.

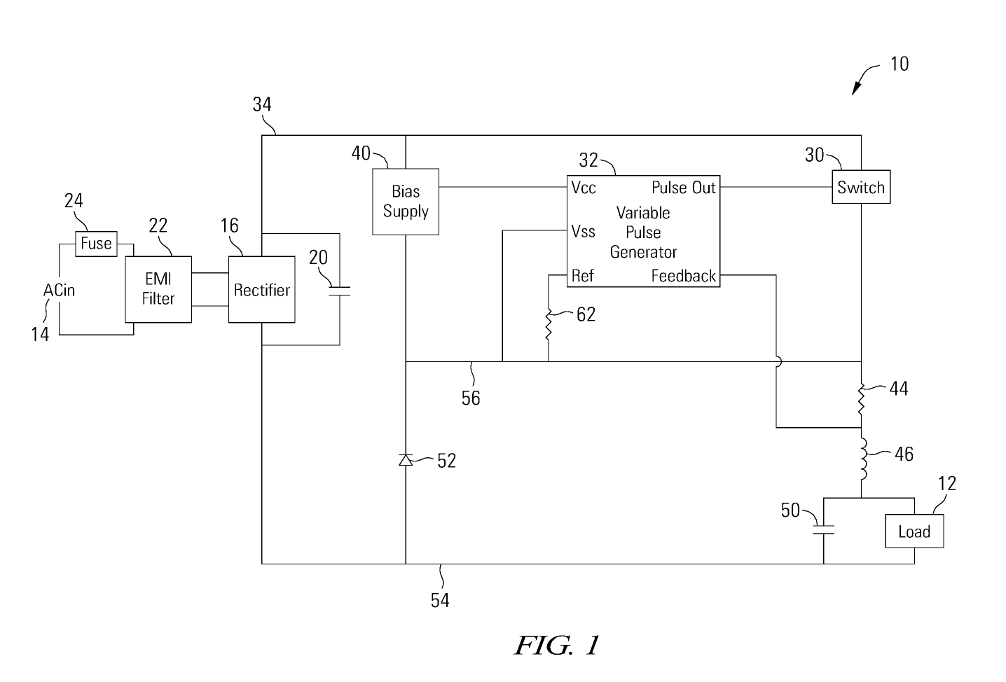

An example embodiment of a dimmable LED power supply 10 is illustrated in FIG. 1, in which a load 12 such as one or more LEDs is powered based on an alternating current (AC) input 14. The AC input 14 is rectified in a rectifier 16 such as a diode bridge and may be conditioned using a capacitor 20. An electromagnetic interference (EMI) filter 22 may be connected to the AC input 14 to reduce interference, and a fuse 24 may be used to protect the dimmable LED power supply 10 and wiring from excessive current due to short circuits or other fault conditions. In some embodiments, a short circuit protection may be employed in addition to fuse protection, etc.

Current to the load 12 is regulated or controlled by a switch 30 such as a transistor or other switch, under the control of a variable pulse generator 32. The switch 30 may include any suitable type of transistor or other device, such as a bipolar transistor, including bipolar junction transistors (BJTs) and insulated gate bipolar transistors (IGBTs), or a field effect transistor (FET) including N channel and/or P channel FETs such as junction FETs (JFETs), metal oxide semiconductor FETs (MOSFETs), metal insulator FETs (MOSFETs), metal emitter semiconductor FETs (MESFETs) of any type and material including but not limited to silicon, gallium arsenide, indium phosphide, gallium nitride, silicon carbide, silicon germanium, diamond, graphene, and other binary, ternary and higher order compounds of these and other materials. In addition, complementary metal oxide semiconductor N and P channel MOSFET (CMOS), heterojunction FET (HFET) and heterojunction bipolar transistors (HBT), bipolar and CMOS (BiCMOS), modulation doped FETs, (MODFETs), etc, and can be made of any suitable material including ones made of silicon, gallium arsenide, gallium nitride, silicon carbide, etc. which, for example, has a suitably high voltage rating.

A feedback loop based on the current through the switch 30 causes, as an example but in no way limiting or limited to, the variable pulse generator 32 to control the switch 30 to adjust the current through the switch 30 and therefore through the load 12. The variable pulse generator 32 may use any suitable control scheme, such as duty cycle control, frequency control, pulse width control, pulse width modulation, etc. Any type of topology including, but not limited to, constant on time, constant off time, constant, frequency, variable frequency, variable duration, discontinuous, continuous, critical conduction modes of operation, CUK, SEPIC, boost-buck, buck-boost, buck, boost, etc. may be used with the present invention. The use of the term variable pulse generator is not intended to be limiting in any way or form but merely to attempt to describe part of the function performed by the present invention, namely to provide a signal that switches power (i.e., current and voltage) to a load such as the LED discussed in the present invention. The variable pulse generator can be made, designed, built, manufactured, implemented, etc. in various ways including those involving digital logic, digital, circuits, state machines, microelectronics, microcontrollers, microprocessors, field programmable gate arrays (FPGAs), complex logic devices (CLDs), microcontrollers, microprocessors, analog circuits, discrete components, band gap generators, timer circuits and chips, ramp generators, half bridges, full bridges, level shifters, difference amplifiers, error amplifiers, logic circuits, comparators, operational amplifiers, flip-flops, counters, AND, NOR, NAND, OR, exclusive OR gates, etc. or various combinations of these and other types of circuits.

A bias supply 40 provides a suitable voltage level based on the voltage at the input 34 to power the variable pulse generator.

A sense resistor 44 is placed in series with the switch 30 or in any other suitable location to detect the current through the switch 30 or any other desired current, for use in controlling the switch 30. An inductor 46 is connected in series with the switch 30, and the load 12 and a parallel capacitor 50 are also connected in series with the switch 30 and the inductor 46. A diode 52 is connected between the system ground 54 and a local ground 56. When the switch 30 is turned on, current flows from the input 34 through the switch 30 and through the load 12 and energy is stored in the inductor 46. When the switch 30 is turned off, energy stored in the inductor 46 is released through the load 12, with the diode 52 providing a return path for the current through the load 12 and back through the sense resistor 44 and inductor 46.

The current through the sense resistor is also used, for example, to feedback and control the current through the load via, for example, the op amp and/or comparator and provide for a constant current both a full input voltage and during dimming. In some embodiments, the control for variable pulse generator has a fixed reference voltage that is compared against the signal from the sense resistor and adjusts the pulse width, as and if needed, to ensure that the maximum current through the load is not exceeded during dimming and when used with an external dimmer of any type and also, of course, when there is no dimming or external dimmer (i.e., the input voltage is a fixed AC or DC value—for example 120 VAC or 240 VAC, etc.). In other embodiments and implementations, for example, the width and or period (or, for example, the on and off times) of the variable pulse generator is/are actively adjusted and controlled during dimming by varying the reference signal in response to the external dimming level.

The power factor can be controlled to be very high and extremely close to unity by, for example, the variable pulse generator 32, providing a very high power factor and efficiency and, for example, also a stable output constant current or, if desired in other applications and embodiments, a stable output voltage.

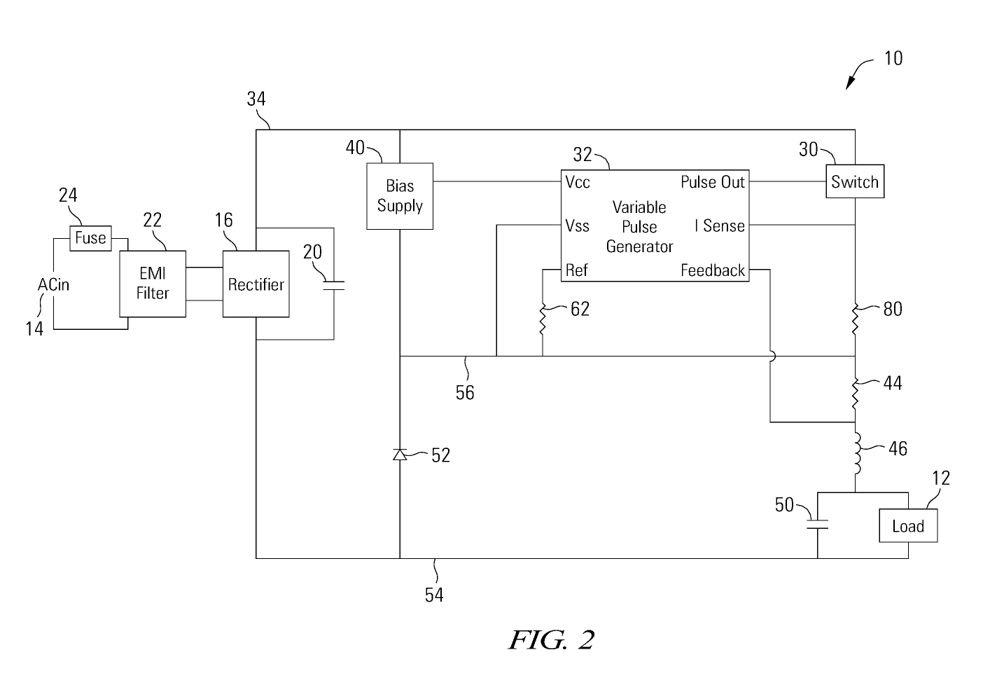

As illustrated in FIG. 2, an additional current sense resistor 80 may be placed in series with the switch 30 to measure the input current. (In contrast, the sense resistor 44 located between the load 12 and the local ground 56 provides an instantaneous and/or average load current measurement, including energy stored and released by the inductor 46.) Feedback from the sense resistor 80 may be provided to the variable pulse generator 32 to limit or turn off the input current if over-current conditions are detected, such as during periods of high inrush currents or periods of input overvoltage. In addition, other features such as over-temperature, optical feedback, etc. can also be included in the present invention.

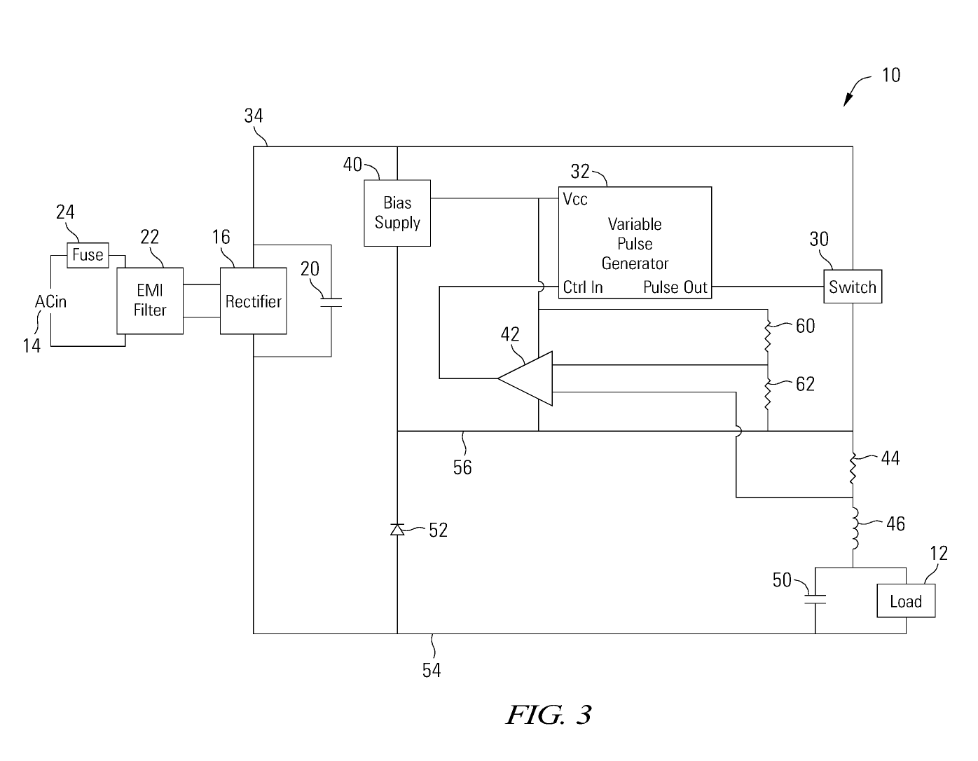

Referring now to FIG. 3, the feedback to the variable pulse generator 32 may be based on the voltage from the bias supply 40 as well as the current through the sense resistor 44. In this embodiment, the bias supply 40 also powers any powered components in the feedback loop, such as, for example, an operational amplifier (op-amp) 42; in another embodiment a comparator may be used in place or in conjunction with the op amp 42. Nothing in this document shall be limiting on the present invention in terms of the choice of analog and digital circuits, discrete or integrated in any way or form

In this embodiment, the feedback loop includes, for example, the op-amp 42, with one input connected to a voltage divider (such as resistors 60 and 62) providing a voltage reference based on the input 34, and another input connected to the sense resistor 44 to provide a voltage based on the current through the sense resistor 44 (and therefore through the switch 30 and the load 12). The output of the op-amp 42 is fed back to a control input on the variable pulse generator 32, so that the current through the switch 30, referenced to the voltage from the bias supply 40, controls the pulse width at the switch 30. The op-amp 42 may comprise a difference amplifier, a summing amplifier, or any other suitable device, component, sub-circuit, circuit, etc. for controlling or creating the variable pulse generator 32 based on the current through the switch 30 and the voltage at the input 34.

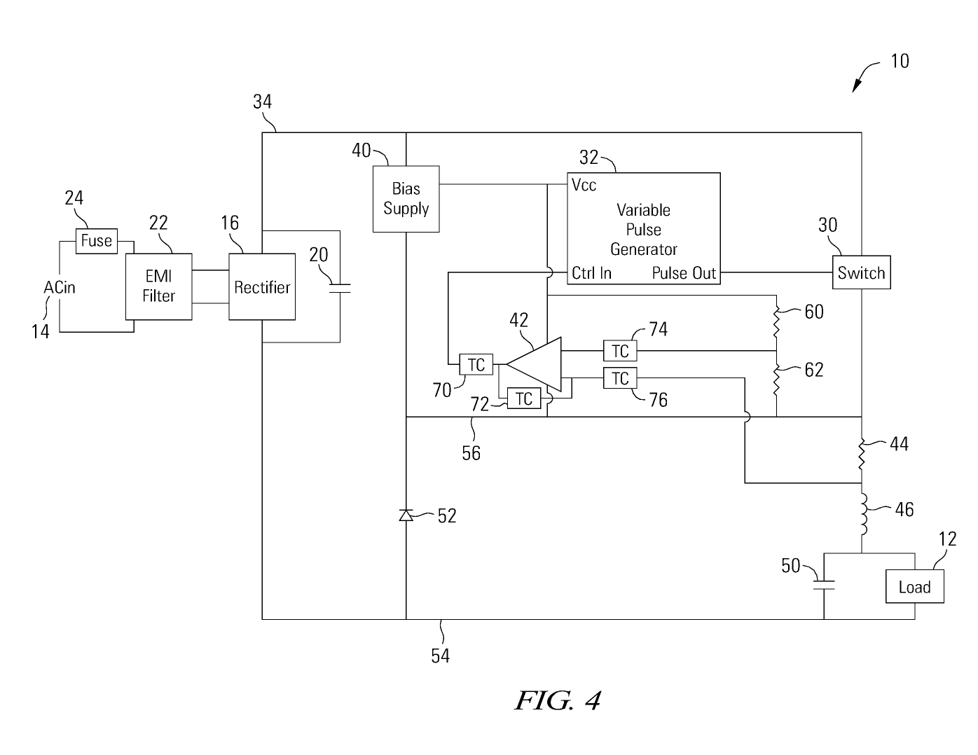

Referring now to FIG. 4, time constants 70, 72, 74 and 76 may be included in various locations in the feedback loop or in other locations as desired to implement different control schemes or to adjust the response of the dimmable LED power supply 10. Time constants (e.g., 74 and 76) may be connected to the local ground 56 if and as needed, for example if the time constant consists of an RC network with the signal passing through a series resistor and with a shunt capacitor connected to the local ground 56.

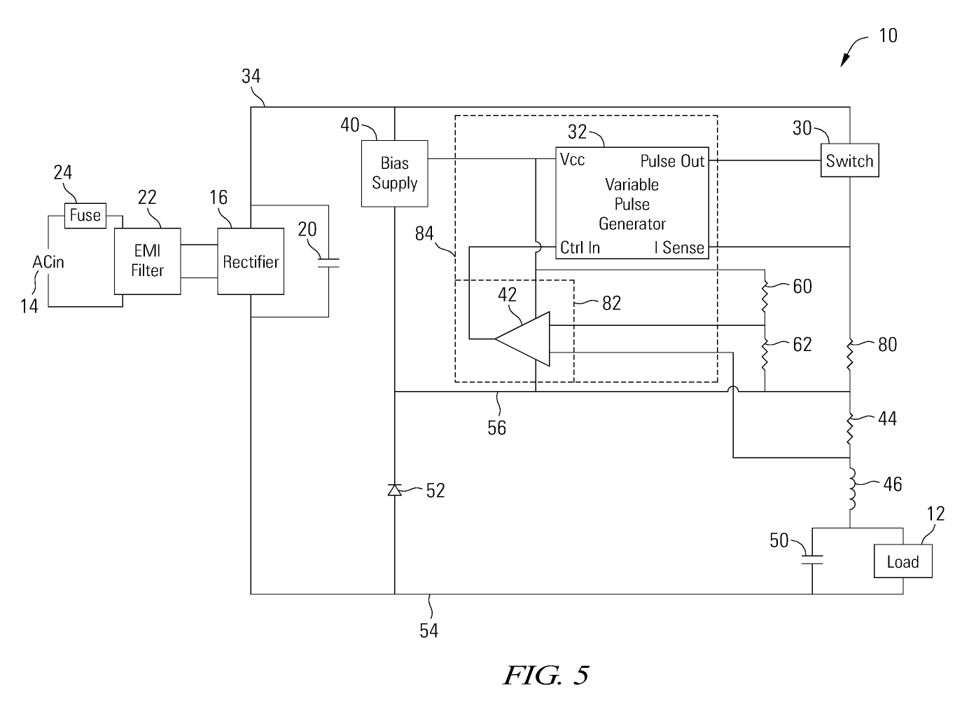

Referring now to FIG. 5, an additional current sense resistor 80 may be placed in series with the switch 30 to measure the input current. In contrast, the sense resistor 44 located between the load 12 and the local ground 56 provides information on and an instantaneous and/or average load current measurement, including energy stored and released by the inductor 46. Time constants, where needed, including across sense resistor 44 may be added as needed for various embodiments and implementations of the present invention. Feedback from the sense resistor 80 may be provided to the variable pulse generator 32 to limit or turn off the input current if over-current conditions are detected, such as during periods of high inrush currents. In other embodiments, feedback from the sense resistor 80 may be processed or handled in other portions of the dimmable LED power supply 10 to make any desired changes in response to measured input current.

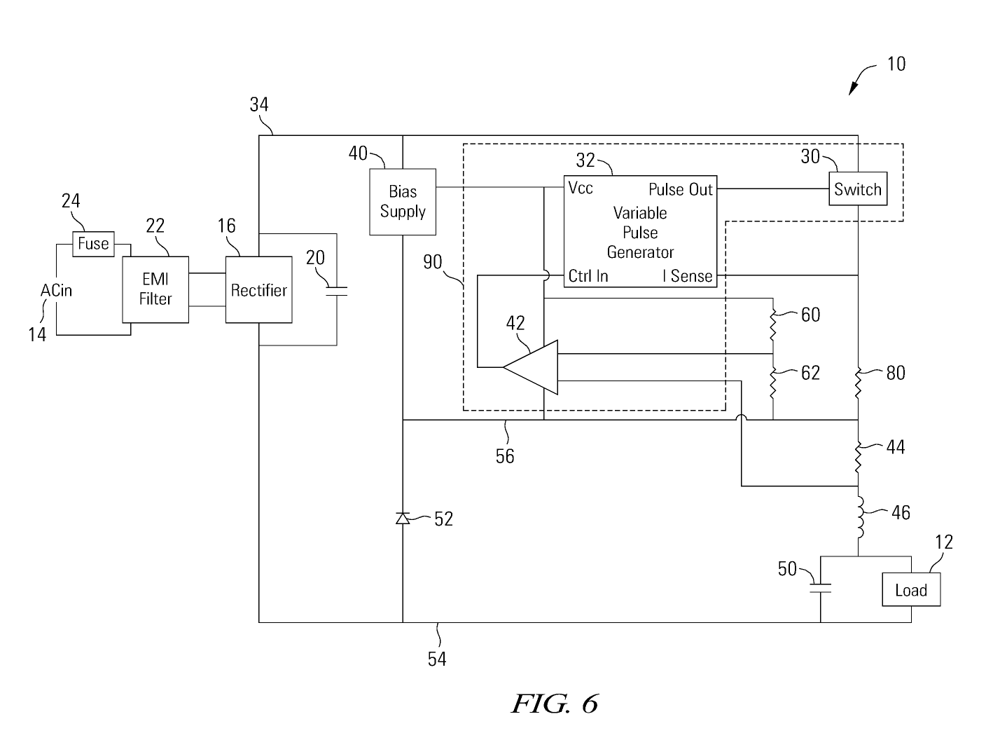

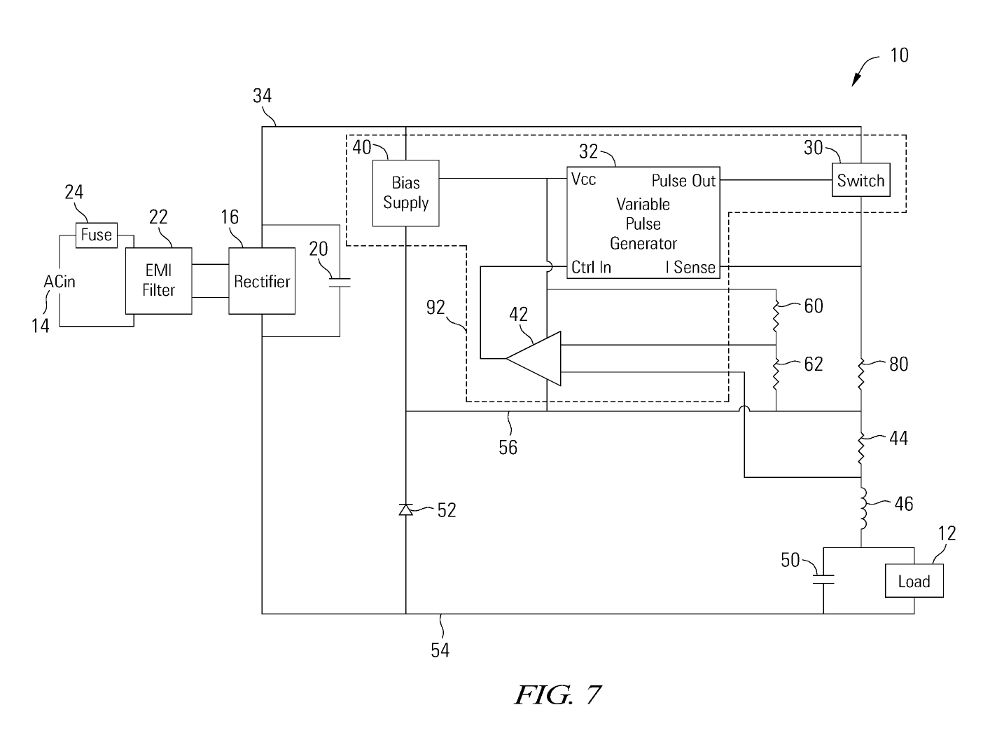

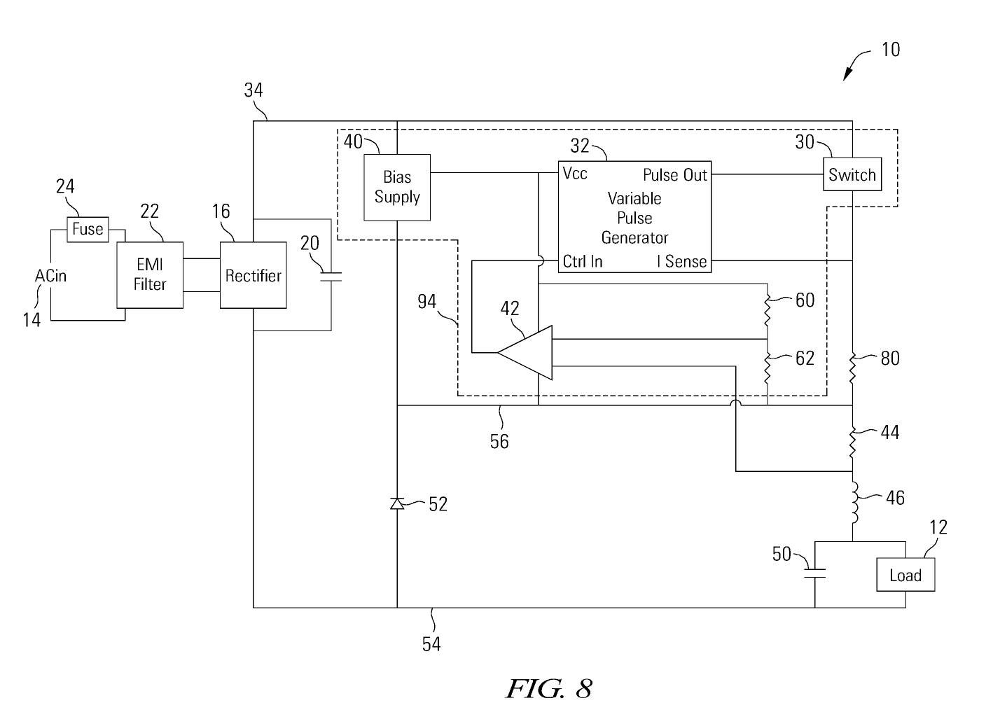

Various portions of the dimmable LED power supply 10 may be embodied in one or more integrated circuits (ICs). For example, the op-amp 42 may be embodied in an integrated circuit 82, or the op-amp 42 and variable pulse generator 32 may be embodied together in a single integrated circuit 84, etc. These or other combinations of portions of the dimmable LED power supply 10 may be integrated to simplify the overall dimmable LED power supply 10, reducing parts count, size and cost. FIGS. 6-8 show some example embodiments of a dimmable LED power supply 10 in which various components are included in an IC. For example, as illustrated in FIG. 6, an integrated circuit 90 may include the op-amp 42, variable pulse generator 32 and switch 30. As illustrated in FIG. 7, an integrated circuit 92 may also include the bias supply 40. As illustrated in FIG. 8, an integrated circuit 94 may also include one or more of the resistors (e.g., 60 and 62). Other embodiments may include one or more each of op amps and comparators. The exact components and combinations illustrated here are for demonstrating potential embodiments and implementations and should not be viewed as limiting in any way or form for the present invention.

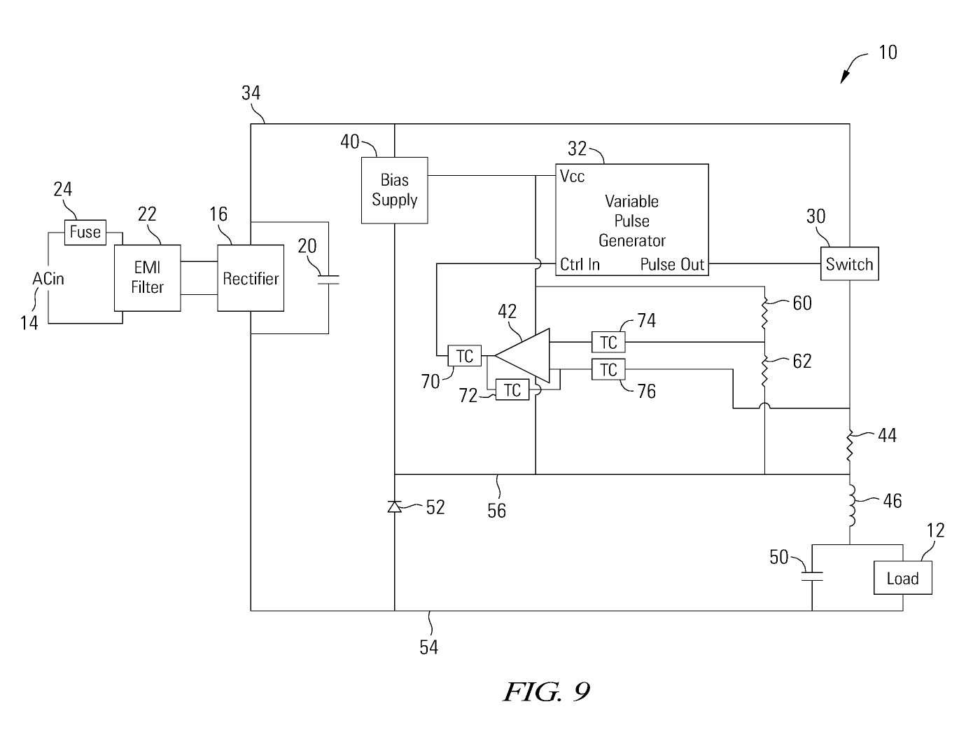

As illustrated in FIG. 9, the sense resistor 44 may be connected above the local ground 56 in another embodiment. The current through the switch 30 may be sensed using any suitable device or circuit, connected in any of a number of suitable locations in the dimmable LED power supply 10 including within an IC or by using either (or both) discrete BJTs and FETs. This sensing of the current can be used to limit, stop, turn-off or reduce, etc. the pulse when the current is too high.

The sensing of the circuit can also be used to turn-on, increase, etc. the pulse in other embodiments. In addition, any or all of the sense resistors in the present invention could be replaced with, for example, sense transformers or any other type of current sensing device or component, etc. In some embodiments, the inductor can be replaced by a transformer in, for example, either the forward or flyback mode of operation or other modes of operation. Such embodiments can be of an isolated design (i.e., where the output is electrically isolated from the input) or a non-isolated design depending, for example, on the exact implementation, specifications, application, etc. Again, nothing in this section should be viewed as limiting in any way or form for the present invention.

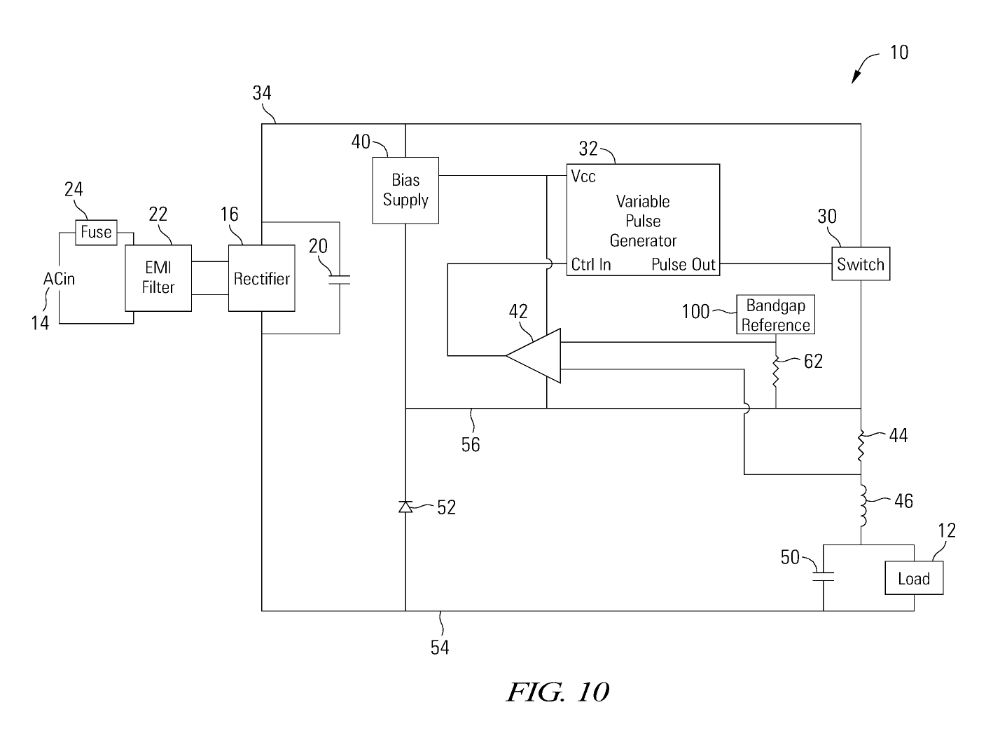

In various different embodiments, the reference voltage to the op-amp 42 may be obtained in any suitable desired manner, such as using a constant voltage reference or using a reference voltage that is proportional to the voltage at the input 34. For example, as illustrated in FIG. 10, the voltage reference for the op-amp 42 may be provided by a bandgap reference 100, which may also be included in a single integrated circuit with other components if desired and can be applied to any of the embodiments of the present invention including the embodiments shown in most of FIGS. 1 through 10. The bandgap reference 100 may be powered by the input 34, the bias supply 40 or any other power supply or, for example, internally from within an IC. In other embodiments and implementations a constant or variable current source that, for example, feeds a resistor may be used as the reference voltage source and may be, for example, a fixed value or varying during dimming in response to the dimming level. Other methods can be implemented to realize the reference signal with the above being some examples of such. Again, the above is merely examples of the reference signal and should not be viewed as limiting in any way or form for the present invention. Additional power bias supplies and capabilities may be added to the present invention if so desired including additional ways to bias and provide power to the present invention. In another embodiment, the reference voltage can be made to vary with the dimming level and thus control the output as a function of the dimming level.

While illustrative embodiments have been described in detail herein, it is to be understood that the concepts disclosed herein may be otherwise variously embodied and employed.

What is claimed is:

1. An apparatus for dimmably supplying power, the apparatus comprising:
an input power terminal;
a switch connected to the input power terminal;
an inductor connected in series with the switch;
a load terminal connected in series with the switch and with the inductor; and
a variable pulse generator operable to control the switch to regulate a current to the load terminal based at least in part on a feedback signal from a node in series with the load terminal and at least in part on a voltage reference signal.

2. The apparatus of claim 1, further comprising a bias power supply connected to the input power terminal, the bias power supply being operable to adapt a voltage level at the input power terminal and to supply power to the variable pulse generator from the input power terminal.

3. The apparatus of claim 1, wherein the voltage reference signal comprises a constant voltage supply.

4. The apparatus of claim 1, wherein the voltage reference signal is based on a voltage level at the input power terminal, and wherein the variable pulse generator is operable to control the current to the load terminal based at least in part on the voltage level at the input power terminal.

5. The apparatus of claim 2, further comprising a sense resistor connected in series between the switch and the inductor, wherein the node connected to the feedback signal is located between the sense resistor and the inductor.

6. The apparatus of claim 5, wherein an upper node between the sense resistor and the switch is connected to a local ground input of the variable pulse generator.

7. The apparatus of claim 6, wherein the input power terminal comprises a source node and a return node, and wherein the load terminal comprises a first node and a second node, wherein the source node is connected to the switch, the first node of the load terminal is connected to the inductor, and the return node is connected to the second node of the load terminal, the apparatus further comprising a diode connected between the return node and the local ground input of the variable pulse generator, the diode being operable to provide a return path for the current through load terminal when the switch is off.

8. The apparatus of claim 5, further comprising:
a second sense resistor connected between the switch and the sense resistor; and
a second feedback signal connected to the variable pulse generator and to a node between the switch and the second sense resistor.

9. The apparatus of claim 1, further comprising:
a rectifier connected between the input power terminal and an alternating current input;
an EMI filter connected to the alternating current input; and
a fuse connected to the alternating current input.

10. The apparatus of claim 5, further comprising an operational amplifier operable to amplify a difference between the feedback signal and a reference voltage to yield the voltage reference signal, wherein the reference voltage is derived from the bias power supply.

11. The apparatus of claim 10, further comprising at least one time constant circuit connected to the operational amplifier.

12. The apparatus of claim 11, wherein the variable pulse generator, the operational amplifier and the bias power supply are embodied in an integrated circuit.

13. The apparatus of claim 1, wherein the variable pulse generator is embodied in an integrated circuit.

14. The apparatus of claim 5, further comprising an operational amplifier operable to amplify a difference between the feedback signal and a reference voltage to yield the voltage reference signal, wherein the reference voltage is provided by a bandgap reference.

15. The apparatus of claim 1, wherein the variable pulse generator is operable to control the switch to regulate the current to the load terminal at least in part to optimize a power factor of the apparatus.

16. The apparatus of claim 15, wherein the variable pulse generator is operable to control the switch to regulate the current to the load terminal at least in part based on instantaneous levels in the current to the load terminal.

17. The apparatus of claim 15, wherein the variable pulse generator is operable to control the switch to regulate the current to the load terminal at least in part based on average levels in the current to the load terminal.

18. A method of dimmably controlling an electrical current, the method comprising:
controlling a switch between a power input and a load output using a variable pulse generator;
measuring a current level to the load output;
adjusting an output of the variable pulse generator based at least in part on the current level;
energizing an inductor in series with the switch and the load output when the switch is on; and
providing a return path through the load output and the inductor when the switch is off.

19. The method of claim 18, further comprising referencing the current level to a voltage at the power input to adjust the output of the variable pulse generator.

20. An apparatus for dimmably supplying power, the apparatus comprising:
an input power terminal;
a switch connected to the input power terminal;
an inductor connected in series with the switch;
a load terminal connected in series with the switch and with the inductor;
a sense resistor connected in series between the switch and the inductor, wherein the node connected to the feedback signal is located between the sense resistor and the inductor, and wherein an upper node between the sense resistor and the switch is connected to a local ground input of the variable pulse generator;
a variable pulse generator operable to control the switch to regulate a current to the load terminal based at least in part on a feedback signal from a node in series with the load terminal and at least in part on a voltage reference signal, wherein the voltage reference signal is based on a voltage level at the input power terminal, and wherein the variable pulse generator is operable to control the current to the load terminal based at least in part on the voltage level at the input power terminal; and
a bias power supply connected to the input power terminal, the bias power supply being operable to adapt a voltage level at the input power terminal and to supply power to the variable pulse generator from the input power terminal.
